(19) United States
(12) Patent Application Publication
(10) Pub. No.: US 2009/0100562 A1
(43) Pub. Date: Apr. 23, 2009

(54) RUBBER HEATPROOF MITTEN

(76) Inventor: Hsiao-Hua LIANG, Nantou Hsien (TW)

Correspondence Address: Hershkovitz & Associates, LLC, 2845 Duke Street, Alexandria, VA, 22314, US

(21) Appl. No.: 12/337,226

(22) Filed: Dec. 17, 2008

Related U.S. Application Data
(63) Continuation-in-part of application No. 11/075,755, filed on Mar. 10, 2005.

(51) Int. Cl. A47J 45/10; A41D 19/01

(52) U.S. Cl. 2/20; 2/158

(57) ABSTRACT

A rubber heatproof mitten is essentially a bag. The bag is shaped as cone-like and has an open end, a closed end, an outer surface, an inner surface, two heatproof braces, a wave section, multiple top ribs and at least one outer rib. The closed end is formed on a narrow side of the cone-like bag and has a finger section and a thumb section. The finger section and the thumb section both have a palm side surface. The two heatproof braces are respectively formed on the palm side surfaces. Each heatproof brace has an enhancement layer, multiple connecting ribs and multiple nubs. The wave section is integrally formed between the closed end and the open end of the bag. The top ribs are separately formed longitudinally on the inner surface of the bag. The outer rib is formed on the outer surface of the bag.

The present invention is a continuation-in-part of application Ser. No. 11/075,755, filed on Mar. 10, 2005.

### BACKGROUND OF THE INVENTION

1. Field of the Invention

The present invention relates to a heatproof mitten, and more particularly to a rubber-made heatproof mitten that can keep a person's hand from being burned by hot dish, pot or the like.

2. Description of Related Art

Heatproof mittens are normally using in the kitchen to help a person take a hot dish out of the oven or take a hot dish to the diner table. Heatproof mittens can be formed by clothing, fabric or rubber, where a rubber made heatproof mitten is durable and convenient to produce.

A conventional rubber heatproof mitten is essentially a bag. The bag has a closed end and an open end. The closed end of the bag has a finger section and a thumb section. The conventional rubber heatproof mitten must be very thick for isolating heat transformation, which increases material cost, is heavy, cumbersome and is not easy to use especially during wearing and taking off.

A person puts his or her hand into the heatproof mitten from the open end. The person's fingers and thumb slide respectively into the finger section and the thumb section. The person can use the finger section and the thumb section to hold a hot dish and transfer the hot dish from one location to another. The bag can protect the person's hand and keep the person's hand from being burned by the hot dish.

However, the rubber is a soft material, and a person's hand easily sticks to the rubber when the person puts on the rubber heatproof mitten, especially when the person's hand is sweaty as is often the case in a hot kitchen. The person's hand in contact with the inside of the rubber heatproof mitten will sweat more. The sweat causes the heatproof mitten to stick to the skin of the person's hand and causes putting on or taking off the heatproof mitten difficult. Furthermore, an adequate thickness of the heatproof mitten to adequately insulate a person's hand makes bending the person's wrist difficult. Moreover, the person can not immediately take his hand out from the heatproof mitten during serious urgency happened (such as the heatproof mitten is melted and stuck on a hot oven), since the conventional heatproof mitten is mono-width that has a small opening.

To overcome the shortcomings, the present invention provides a rubber heatproof mitten to obviate or mitigate the aforementioned problems.

### SUMMARY OF THE INVENTION

The primary objective of the present invention is to provide a rubber heatproof mitten to hold a hot material that will not cause a person's hand to sweat as much and is more flexible.

The rubber heatproof mitten is essentially a bag. The bag is shaped as cone-like and has an open end, a closed end, an outer surface, an inner surface, two heatproof braces, a wave section, multiple top ribs and at least one outer rib. The closed end is formed on a narrow side of the cone-like bag and has a finger section and a thumb section. The finger section and the thumb section both have a palm side surface. The two heatproof braces are respectively formed on the palm side surfaces. Each heatproof brace has an enhancement layer, multiple connecting ribs and multiple nubs. The wave section is integrally formed between the closed end and the open end of the bag. The top ribs are separately formed longitudinally on the inner surface of the bag. The outer rib is formed on the outer surface of the bag.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a rubber heatproof mitten in accordance with the present invention;

FIG. 2 is a cross sectional side view of the rubber heatproof mitten in FIG. 1;

FIG. 3 is front view of the rubber heatproof mitten in FIG. 1; and

FIG. 4 is an operational perspective view of the rubber heatproof mitten in FIG. 1, showing fast taking a hand off from the rubber heatproof mitten.

### DETAILED DESCRIPTION OF THE PREFERRED EMBODIMENT

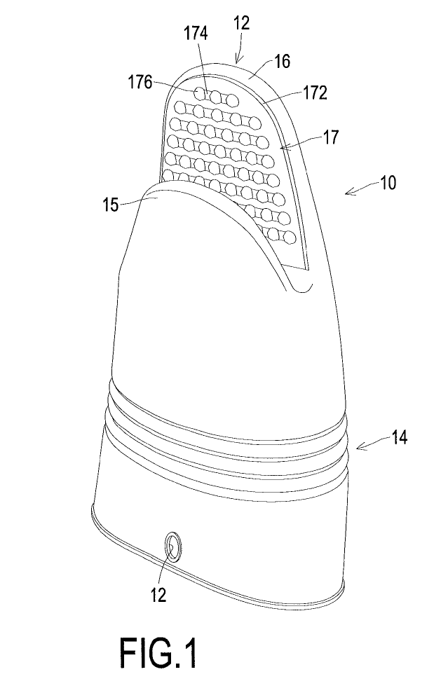

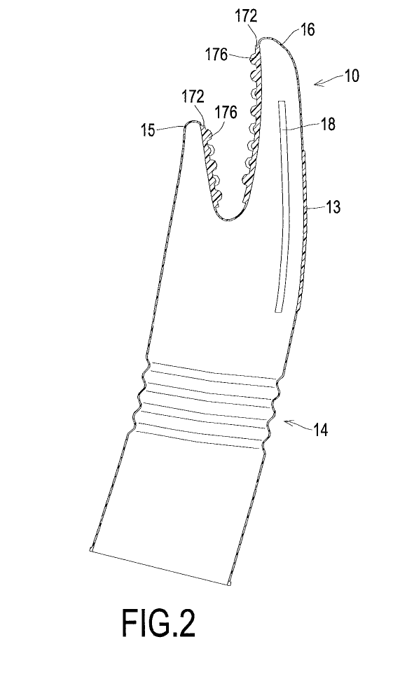

With reference to FIGS. 1, 2 and 3, a rubber heatproof mitten in accordance with the present invention is a bag (10). The bag (10) may be silicon rubber, neoprene or the like rubber made. The bag (10) is shaped as cone-like and has an open end (11), a closed end, an outer surface, an inner surface, two heatproof braces (17), a wave section (14), a hanging hole (12), multiple top ribs (18) and at least one outer rib (13).

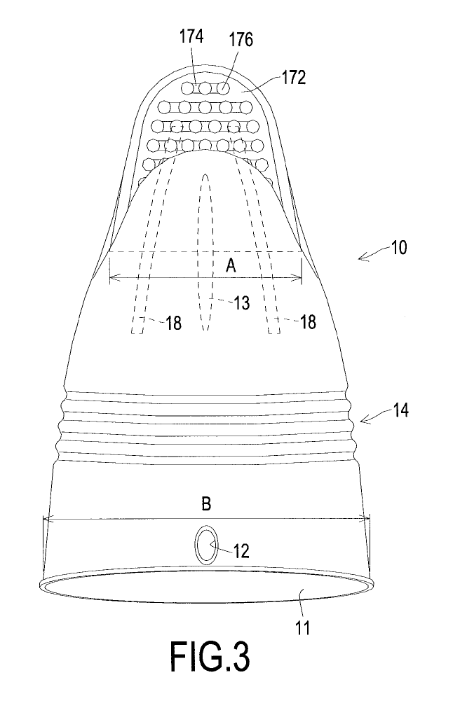

The closed end is formed on a narrow side of the cone-like bag (10) and has a finger section (16) and a thumb section (15). The finger section (16) and the thumb section (15) both have a palm side surface being faced to each other. Furthermore, as shown in FIG. 3, a width (A) of the cone-like bag (10) at an join of the finger section (16) and the thumb section (15) is smaller then a width (B) of the open end (11). After an user's feeling investigation, a preferred ratio between the width A and B is 1:1.5˜1:2, in a preferred embodiment of the present invention, the ratio A:B is 1:1.7.

The two heatproof braces (17) are shaped corresponding to and are respectively formed separately on the palm side surfaces of the finger section (16) and the thumb section (15). Each heatproof brace (17) has an enhancement layer (172), multiple connecting ribs (174) and multiple nubs (176). The enhancement layer (172) is formed on one of the palm side surfaces and has a thickness larger than that of the bag (10). The connecting ribs (174) are separately and parallelly formed on the enhancement layer (172). The nubs (176) are separately formed on the connecting ribs (174) and arranged in lines.

The wave section (14) is integrally formed between the closed end and the open end (11) of the bag (10). Main purpose of the wave section (14) is designed for improving flexibility of the bag (10) so that a person may feel better during wearing the rubber heatproof mitten. The other purpose of the wave section (14) is to deform a smoothing morphology of the inner surface of the bag (10) thereby a person may easily and rapidly wear and take off the rubber heatproof mitten.

The hanging hole (12) is formed though the bag (10) near the open end (11) of the bag (10).

The top ribs (18) are separately formed longitudinally on the inner surface of the bag (10). The top ribs (18) are used for preventing a sweaty hand of a person stick on the inner surface of the bag (10) since a smoothing morphology of the inner surface with no ribs is easy to stick with a human skin.

The at least one outer rib (13) is formed longitudinally on and protrude from the outer surface of the bag (10), where the outer rib (13) is designed for preventing skin of back of hands are burned by an inner surface of an oven during putting hands into the oven.

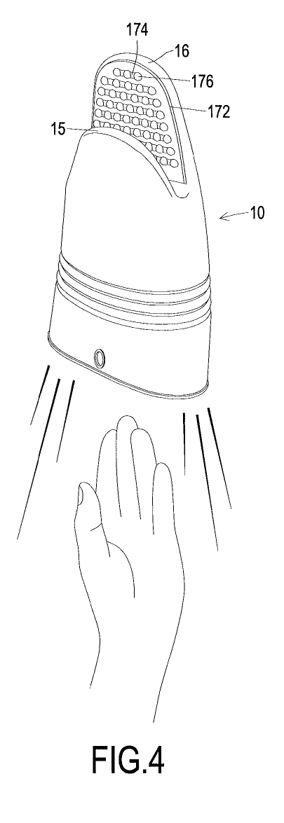

A person puts the rubber heatproof mitten on by inserting his or her hand into the open end (11) of the bag (10). The person's four fingers and the thumb are inserted respectively into the finger section (16) and the thumb section (15). The top ribs (18) and the wave section (14) form air gaps between the inner surface of the bag (10) and a person's hand, thereby the inner surface of the bag (10) will not stick to the person's hand. Sweat from a person's hand will not influence a person from putting on or taking off the rubber heatproof mitten. Moreover, with reference to FIG. 4, a person may rapid and easy to wear or take off his/her hand from the rubber heatproof mitten when serious urgency happened as described.

On the other hand, an average thickness of the rubber heatproof mitten in accordance of the present invention may be reduced without sacrificing ability of heatproof, since the heatproof braces (17) has the enhancement layer (172) with a thicker thickness than that of the bag (10) and the connecting ribs (174). A person may more securely holding a hot material with using the rubber heatproof mitten since a strength and hardness is enhanced from an increased thickness by the heatproof braces (17).

Also, a contact area between the rubber heatproof mitten and a hot material (such as a hot dish) is decreased since the nubs (176), so less heat is transferred from the hot material to the bag (10).

In conclusion, the flexibility of the rubber heatproof mitten are improved by the wave section (14), the insulation of heat of the rubber heatproof mitten are improved by the heatproof braces (17) and the outer rib (13), and ease of wearing or taking off of the rubber heatproof mitten is improved by the wave section (14), the top ribs (18) and a cone-like shape.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A rubber heatproof mitten comprising
a bag being rubber, being shaped as cone-like and having
an open end; and
a closed end being formed on a narrow side of the cone-like bag and having
a finger section having a first palm side surface; and
a thumb section having a second palm side surface, the second palm side surface being faced to the first palm side surface;
an outer surface;
an inner surface;
two heatproof braces being shaped corresponding to and being respectively formed on the first and second palm side surfaces, each heatproof brace having
an enhancement layer being formed on a corresponding palm surface;
multiple connecting ribs being separately formed on the enhancement layer; and
multiple nubs being separately formed on the connecting ribs;
a wave section being integrally formed between the closed end and the open end of the bag;
multiple top ribs being separately formed longitudinally on the inner surface of the bag; and
at least one outer rib being formed longitudinally on and protruding from the outer surface of the bag.

2. The rubber heatproof mitten as claimed in claim 1, wherein the bag has a hanging hole formed through the bag near the open end of the bag.

3. The rubber heatproof mitten as claimed in claim 2, wherein the connecting ribs are formed in parallel.

4. The rubber heatproof mitten as claimed in claim 3, wherein the enhancement layer of each heatproof brace has a thickness thicker than that of the bag.

5. The rubber heatproof mitten as claimed in claim 4, wherein the rubber heatproof mitten is silicon rubber.

6. The rubber heatproof mitten as claimed in claim 3, wherein the rubber heatproof mitten is silicon rubber.

7. The rubber heatproof mitten as claimed in claim 2, wherein the rubber heatproof mitten is silicon rubber.

8. The rubber heatproof mitten as claimed in claim 1, wherein the rubber heatproof mitten is silicon rubber.

9. The rubber heatproof mitten as claimed in claim 1, wherein the enhancement layer of each heatproof brace has a thickness thicker than that of the bag.

10. The rubber heatproof mitten as claimed in claim 5, wherein a width (A) of the bag at an join of the finger section and the thumb section is smaller then a width (B) of the open end, the ratio between the width A and B is 1:1.5 to 1:2.

11. The rubber heatproof mitten as claimed in claim 6, wherein a width (A) of the bag at an join of the finger section and the thumb section is smaller then a width (B) of the open end, the ratio of the width A to B is from 1:1.5 to 1:2.

12. The rubber heatproof mitten as claimed in claim 7, wherein a width (A) of the bag at an join of the finger section and the thumb section is smaller then a width (B) of the open end, the ratio of the width A to B is from 1:1.5 to 1:2.

13. The rubber heatproof mitten as claimed in claim 8, wherein a width (A) of the bag at an join of the finger section and the thumb section is smaller then a width (B) of the open end, the ratio of the width A to B is from 1:1.5 to 1:2.

14. The rubber heatproof mitten as claimed in claim 9, wherein a width (A) of the bag at an join of the finger section and the thumb section is smaller then a width (B) of the open end, the ratio of the width A to B is from 1:1.5 to 1:2.
